(19) United States
(12) Patent Application Publication
(10) Pub. No.: US 2025/0345818 A1
(43) Pub. Date: Nov. 13, 2025

(54) ALL-PLASTIC FOAM PUMP STRUCTURE

(71) Applicant: Majesty Holdings Co.,Ltd., Zhongshan, Guangdong (CN)

(72) Inventors: Peihui LIANG, Zhongshan (CN); Maoyong ZHU, Zhongshan (CN); Yonglei ZHANG, Zhongshan (CN); Jinkao LIANG, Zhongshan (CN)

(73) Assignee: Majesty Holdings Co.,Ltd., Zhongshan, Guangdong (CN)

(21) Appl. No.: 18/862,155

(22) PCT Filed: Mar. 16, 2023
(86) PCT No.: PCT/CN2023/081825

§ 371 Date: Oct. 31, 2024

(30) Foreign Application Priority Data
May 9, 2022 (CN) 202221103391.6

(51) Int. Cl. B05B 11/10; B05B 11/00

(52) U.S. Cl. CPC B05B 11/1087; B05B 11/0032; B05B 11/1077

(57) ABSTRACT

Disclosed is an all-plastic foam pump structure, including a pressing head (1) made of plastic, a mesh passage (2), a pump body (3), a bottle locking cap (4), a main column (5), an air suction plug (6), a liquid suction plug (7), an elastic sleeve (8), and a pump bead (9), where the bottle locking cap (4) is connected to an upper end of the pump body (3) in an inserted manner; the pump body (3) includes an air chamber (31) and a liquid chamber (32) which are provided at the top and bottom; the air suction plug (6) is provided in the air chamber (31) and connected to the pressing head (1) in an inserted manner, and the mesh passage (2) is arranged between the air suction plug (6) and the pressing head (1); an upper end of the main column (5) extends out of the air chamber (31) and is connected to the air suction plug (6); when the pressing head (1) is pressed downwards, the main column (5) moves downwards together with the air suction plug (6); the liquid suction plug (7) is provided in the liquid chamber (32) and is connected to a lower end of the main column (5); the elastic sleeve (8) sleeves an outer side of the main column (5) and is an elastic plastic annular piece with an opening arranged on a side surface; the pump bead (9) is provided at an inlet of a lower end of the liquid chamber (32). All assemblies of the foam pump are made of plastic and may be recycled without disassembly and classification, improving the recycling efficiency.

### FIELD OF THE INVENTION

The present disclosure relates to the technical field related to foam pumps, and particularly to an all-plastic foam pump structure.

### BACKGROUND OF THE INVENTION

Foam pumps bring convenience to life as a liquid extraction tool for containing body wash and shampoo. In the existing foam pump, a metal spring is generally used as a rebounding apparatus of a pressing head, and a glass bead is used as a one-way sealing piece. Therefore, the existing foam pump usually includes plastic, metal, and glass parts. When recycling, the foam pump needs to be disassembled and then classified for recycling, which is inconvenient and increases the labor cost of recycling.

The present disclosure is provided based on this situation.

### SUMMARY OF THE INVENTION

In view of this, one of the objects of the present disclosure is to provide an all-plastic foam pump structure which is easy to recycle without disassembly and reduces the recycling cost.

The technical solution adopted by the present disclosure to solve its technical problem is as follows.

An all-plastic foam pump structure is provided, including a pressing head made of plastic, a mesh passage, a pump body, a bottle locking cap, a main column, an air suction plug, a liquid suction plug, an elastic sleeve, and a pump bead, where the bottle locking cap is connected to an upper end of the pump body in an inserted manner; the pump body includes an air chamber and a liquid chamber which are provided at the top and bottom; the air suction plug is provided in the air chamber and connected to the pressing head in an inserted manner, and the mesh passage is arranged between the air suction plug and the pressing head; an upper end of the main column extends out of the air chamber and is connected to the air suction plug; when the pressing head is pressed downwards, the main column moves downwards together with the air suction plug; the liquid suction plug is provided in the liquid chamber and is connected to a lower end of the main column; the elastic sleeve sleeves an outer side of the main column and is an elastic plastic annular piece with an opening arranged on a side surface; the pump bead is provided at an inlet of a lower end of the liquid chamber.

Preferably, the main column is provided with a conical guide part; when the pressing head is pressed downwards, the main column moves downwards, and the conical guide part stretches the elastic plastic annular piece.

Preferably, air supplementing holes are arranged on the air suction plug.

Preferably, the elastic plastic annular piece is integrally injection-molded.

Preferably, an outer side surface of the elastic plastic annular piece is provided with reinforcing ribs.

Preferably, a limiting ring limiting a rising height of the liquid suction plug sleeves the main column, and an upper end of the limiting ring is conical.

Preferably, the all-plastic foam pump structure further includes a protective cap made of plastic, and the protective cap covers the pressing head and is clamped to an outer side of the bottle locking cap.

Preferably, the upper end of the pump body is provided with an insertion part configured to be fixed to the bottle locking cap in an inserted manner.

Preferably, a top surface of the pressing head is rough.

Compared with the related art, the beneficial effects of the present disclosure are as follows. All parts of the present disclosure are made of plastic and are environmentally friendly and safe. In addition, the present disclosure may be recycled without disassembly and classification, which reduces the labor cost in recycling and improves the recycling efficiency.

### BRIEF DESCRIPTION OF THE DRAWINGS

FIG. 1 is a sectional view of the present disclosure;

FIG. 2 is a sectional view of the present disclosure when a pressing head is pressed downwards;

FIG. 3 is a schematic structural diagram of an air suction plug of the present disclosure;

FIG. 4 is a schematic structural diagram of a main column of the present disclosure;

FIG. 5 is a schematic structural diagram of the present disclosure after a main column, an elastic plastic annular piece, and a limiting ring are combined;

FIG. 6 is a schematic structural diagram of the present disclosure after a main column, an elastic plastic annular piece, and a limiting ring are combined when a pressing head is pressed downwards;

FIG. 7 is a state diagram of the present disclosure when an elastic plastic annular piece is contracted; and

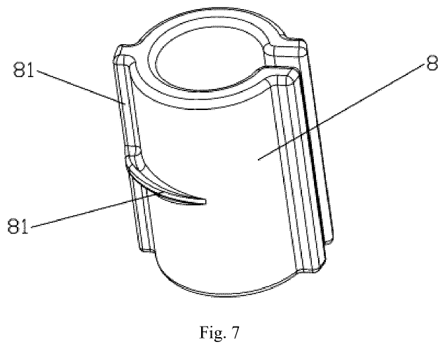

FIG. 8 is a state diagram of the present disclosure when an elastic plastic annular piece is expanded.

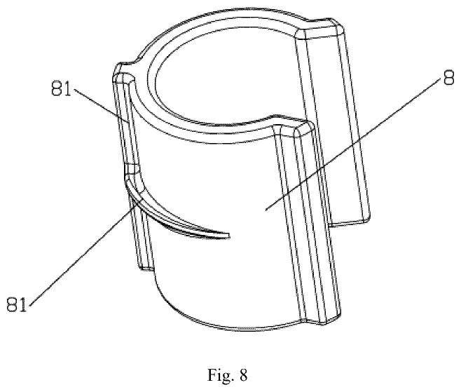

### DETAILED DESCRIPTION OF THE EMBODIMENTS

The technical solutions in the embodiments of the present disclosure will be clearly and completely described below in conjunction with the accompanying drawings.

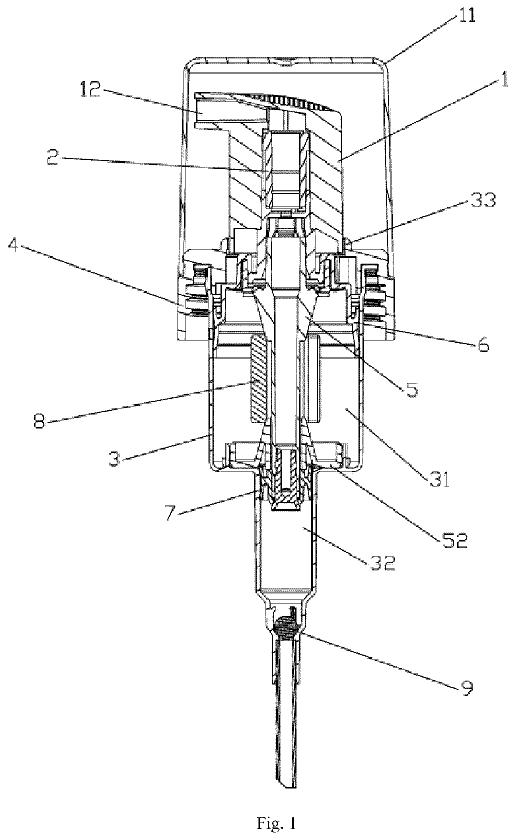

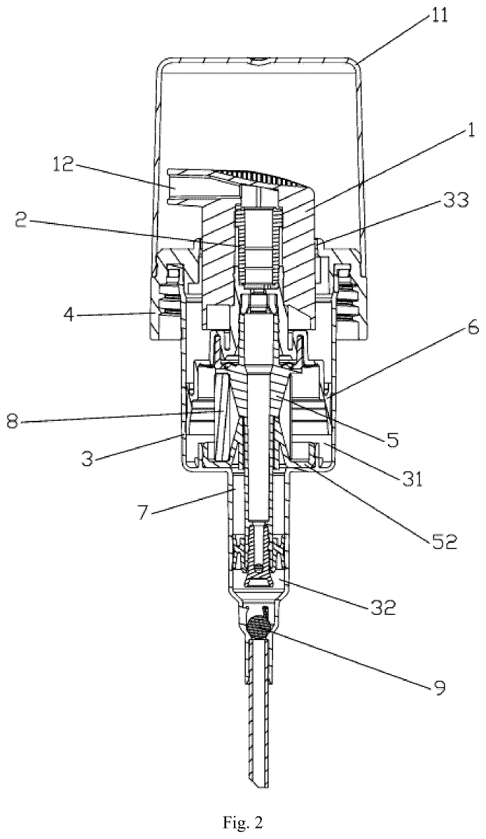

As shown in FIGS. 1 and 2, an all-plastic foam pump structure is provided, including a pressing head 1 made of plastic, a mesh passage 2, a pump body 3, a bottle locking cap 4, a main column 5, an air suction plug 6, a liquid suction plug 7, an elastic sleeve 8, and a pump bead 9. The bottle locking cap 4 is connected to an upper end of the pump body 3 in an inserted manner. The pump body 3 includes an air chamber 31 and a liquid chamber 32 which are provided at the top and bottom. The air suction plug 6 is provided in the air chamber 31 and connected to the pressing head 1 in an inserted manner, and the mesh passage 2 is arranged between the air suction plug 6 and the pressing head 1. An upper end of the main column 5 extends out of the air chamber 31 and is connected to the air suction plug 6. When the pressing head 1 is pressed downwards, the main column 5 moves downwards together with the air suction plug 6. The liquid suction plug 7 is provided in the liquid chamber 32 and is connected to a lower end of the main column 5. The elastic sleeve 8 sleeves an outer side of the main column 5 and is an elastic plastic annular piece with an opening arranged on a side surface. The pump bead 9 is provided at an inlet of a lower end of the liquid chamber 32. The present disclosure has a simple structure and is easy to manufacture. Assemblies of the foam pump are all made of plastic, without metal and glass components, and may be recycled without disassembly and classification, which reduces the labor cost in recycling, improves the recycling efficiency, facilitates recycling, and is environmentally friendly and economical.

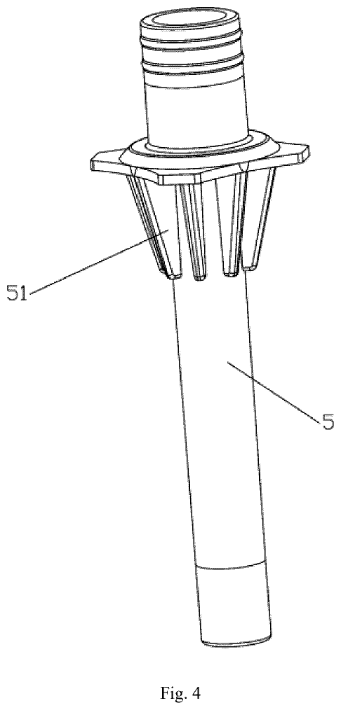

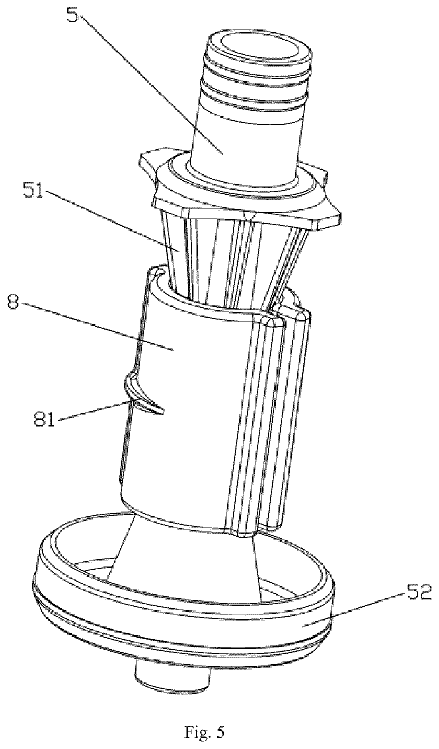

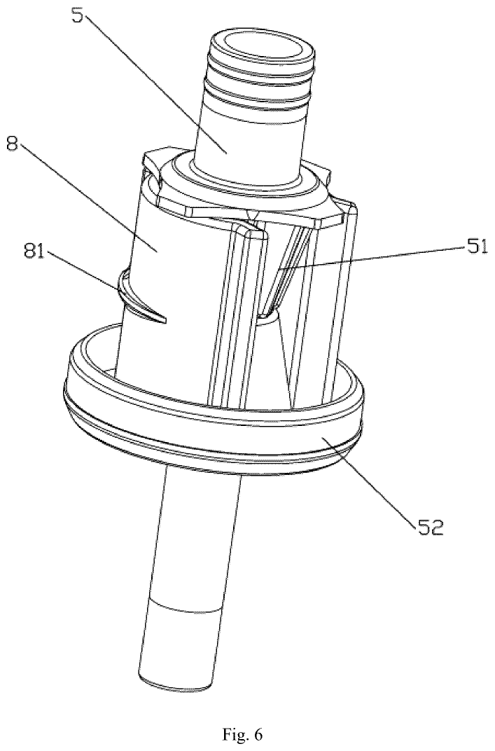

As shown in FIGS. 4 to 6, the main column 5 is provided with a conical guide part 51. When the pressing head 1 is pressed downwards, the main column 5 moves downwards, and the conical guide part 51 stretches the elastic plastic annular piece. At this time, the elastic plastic annular piece is in a radially expanded state. After the external force acting on the pressing head 1 is removed, the elastic plastic annular piece contracts to an initial state, thereby achieving the resetting of the pressing head 1.

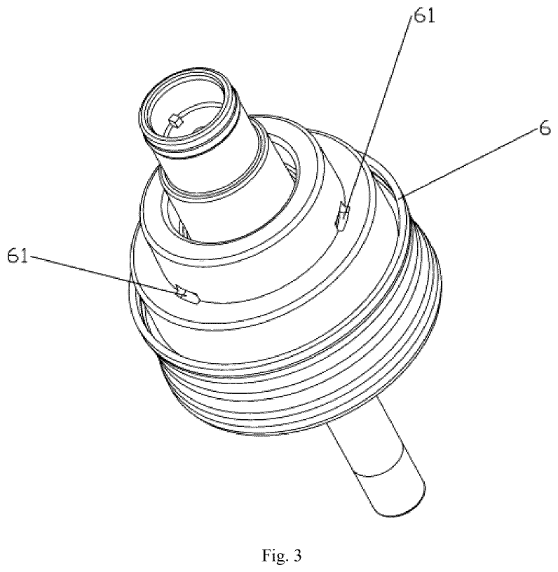

As shown in FIG. 3, air supplementing holes 61 are arranged on the air suction plug 6.

When in use, the pressing head 1 is pressed to drive the air suction plug 6 to move downwards together with the main column 5 and the liquid suction plug 7, and the air suction plug 6 squeezes the air in the air chamber 31 downwards and then pumps it out. Meanwhile, after the main column 5 moves down a distance, a communication passage between the main column 5 and the liquid chamber 32 is opened, and the liquid suction plug 7 is driven to move downwards to pump a solution in the liquid chamber 32 out via the main column 5. The air pumped out by the air chamber 31 is mixed with the liquid pumped out by the liquid chamber 32 to generate foam through the mesh passage 2, and then the foam is sprayed out through a foam nozzle 12. After the external force acting on the pressing head 1 is removed, the elastic plastic annular piece contracts to the initial state, and the pressing head 1, the air suction plug 6, the main column 5, and the liquid suction plug 7 rise upwards. A closed space between the air suction plug 6 and the air chamber 31 forms a negative pressure, and the air is supplemented inwardly from the air supplementing holes 61. Meanwhile, after the main column 5 moves up a distance, the communication passage between the main column 5 and the liquid chamber 32 is closed, and the liquid suction plug 7 is driven to move upwards so that a negative pressure is formed in the liquid chamber 32, and the solution in the bottle is flushed away from the pump bead 9 under the action of atmospheric pressure and flows into the liquid chamber 32.

In this embodiment, the elastic plastic annular piece is integrally injection-molded with a simple structure, easy production, and good elasticity.

In this embodiment, an outer side surface of the elastic plastic annular piece is provided with reinforcing ribs 81. The reinforcing ribs 81 extend longitudinally and radially along the elastic plastic annular piece and can enhance the durability of the elastic plastic annular piece and increases the elastic force. In practical use, there may be a plurality of reinforcing ribs 81 provided in parallel.

In this embodiment, a limiting ring 52 limiting a rising height of the liquid suction plug 7 sleeves the main column 5, and an upper end of the limiting ring 52 is conical. When the pressing head 1 is pressed downwards, the elastic plastic annular piece can be guided to radially expand so that the elastic plastic annular piece can be expanded smoothly.

In this embodiment, the all-plastic foam pump structure further includes a protective cap 11 made of plastic, and the protective cap 11 covers the pressing head 1 and is clamped to an outer side of the bottle locking cap 4. The structure is simple, convenient, and easy to use, and can prevent external dust and bacteria from adhering to or blocking the end of the pressing head 1, playing the role of protecting and shielding.

In this embodiment, the upper end of the pump body 3 is provided with an insertion part 33 configured to be fixed to the bottle locking cap 4 in an inserted manner, facilitating the assembly and fixing of the foam pump and improving the assembly efficiency.

In this embodiment, a top surface of the pressing head 1 is rough so that a frictional force between a user's hand and the pressing head 1 can be increased to prevent slipping.

The above are merely preferred implementations of the present disclosure, and the technical solutions for achieving the purpose of the present disclosure by substantially the same means all fall within the scope of the present disclosure.

1. An all-plastic foam pump structure, comprising a pressing head (1) made of plastic, a mesh passage (2), a pump body (3), a bottle locking cap (4), a main column (5), an air suction plug (6), a liquid suction plug (7), an elastic sleeve (8), and a pump bead (9), wherein the bottle locking cap (4) is connected to an upper end of the pump body (3) in an inserted manner; the pump body (3) comprises an air chamber (31) and a liquid chamber (32) which are provided at the top and bottom; the air suction plug (6) is provided in the air chamber (31) and connected to the pressing head (1) in an inserted manner, and the mesh passage (2) is arranged between the air suction plug (6) and the pressing head (1); an upper end of the main column (5) extends out of the air chamber (31) and is connected to the air suction plug (6); when the pressing head (1) is pressed downwards, the main column (5) moves downwards together with the air suction plug (6); the liquid suction plug (7) is provided in the liquid chamber (32) and is connected to a lower end of the main column (5); the elastic sleeve (8) sleeves an outer side of the main column (5) and is an elastic plastic annular piece with an opening arranged on a side surface; the pump bead (9) is provided at an inlet of a lower end of the liquid chamber (32).

2. The all-plastic foam pump structure according to claim 1, wherein the main column (5) is provided with a conical guide part (51); when the pressing head (1) is pressed downwards, the main column (5) moves downwards, and the conical guide part (51) stretches the elastic plastic annular piece.

3. The all-plastic foam pump structure according to claim 1, wherein air supplementing holes (61) are arranged on the air suction plug (6).

4. The all-plastic foam pump structure according to claim 1, wherein the elastic plastic annular piece is integrally injection-molded.

5. The all-plastic foam pump structure according to claim 4, wherein an outer side surface of the elastic plastic annular piece is provided with reinforcing ribs (81).

6. The all-plastic foam pump structure according to claim 1, wherein a limiting ring (52) limiting a rising height of the liquid suction plug (7) sleeves the main column (5), and an upper end of the limiting ring (52) is conical.

7. The all-plastic foam pump structure according to claim 1, further comprising a protective cap (11) made of plastic, wherein the protective cap (11) covers the pressing head (1) and is clamped to an outer side of the bottle locking cap (4).

8. The all-plastic foam pump structure according to claim 1, wherein the upper end of the pump body (3) is provided with an insertion part (33) configured to be fixed to the bottle locking cap (4) in an inserted manner.

9. The all-plastic foam pump structure according to claim 1, wherein a top surface of the pressing head (1) is rough.
